(19) United States
(12) Patent Application Publication
(10) Pub. No.: US 2009/0185076 A1
(43) Pub. Date: Jul. 23, 2009

(54) VGA port signal examining apparatus and method thereof

(76) Inventor: Po-Jui Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/008,000

(22) Filed: Jan. 18, 2008

(51) Int. Cl. H04N 5/44

(52) U.S. Cl. 348/558; 348/E05.096

(57) ABSTRACT

This present invention is a VGA port signal examining apparatus and method thereof. By intercepting the analog signals transmitted from the VGA port to the monitor, such as vertical signals, horizontal signals, R-signals, G-signals, and B-signals, and by examining the relative data of analog signals to determine whether the VGA port is normal or not.

### BACKGROUND

1. Field of Invention

The present invention relates to a VGA port signal examining apparatus and method thereof. More particularly, the present invention relates to a VGA port signal examining apparatus and method for examining analog signals transmitted via a VGA port.

2. Description of Related Art

At the present time, a testing engineer has to connect a product's VGA port to a monitor and to verify with bare eyes if the screen output is normal during the Power-On Self-Test, to determine whether a VGA port is functioning properly or not. The testing engineer must have the ability to distinguish the RGB tricolor signals on the screen. But if a testing engineer is insufficiently experienced, or the screen displays too fast, it is difficult for the testing engineer to recognize abnormalities of a VGA port. If the abnormalities occur on a product with a faulty VGA port, the examination must be done when running the Power-On Self-Test of the operating system. Thus a lot of time is required to discover problem products. Therefore the test of a VGA port in the prior art must improve.

### SUMMARY

For this reason, the present invention provides a VGA port signal examining apparatus and method thereof, applying for intercepting analog signals transmitted from the VGA port to the monitor. Examining the relative data of analog signals, such as vertical signals, horizontal signals, R-signals, G-signals, and B-signals by a signal judging circuit to determine whether the signals transmitted via the VGA port are normal or not.

The main purpose of the invention is to provide a method to examine the analog signals transmitted from the VGA port to the monitor to determine whether the signals transmitted via the VGA port are normal or not. The method comprises the following steps: judging if a vertical signal is output on a specific frequency via the VGA port; judging if the magnitude of a horizontal signal exceeds a first level-potential; judging if the magnitude of an R-signal exceeds a second level-potential; judging if the magnitude of a G-signal exceeds the second level-potential by the signal judging circuit; and, judging if the magnitude of a B-signal exceeds the second level-potential by the signal judging circuit.

The secondary purpose of the invention is to provide apparatus with which to examine VGA port signals. The apparatus comprises: a signal intercepting module, and a signal judging circuit. The signal intercepting module connects to a VGA port to intercept plural analog signals transmitted from the VGA port to a monitor, such as a vertical signal, a horizontal signal, an R-signal, a G-signal, and a B-signal. And, the signal judging circuit, linked to the signal intercepting module, compares the magnitudes of analog signals with specific examination data set by a user to determine whether analog signals transmitted via the VGA port being are normal or not.

Therefore, products with faulty VGA ports can be recognized in a short time, thus preventing estimating with bare eyes and reducing human errors. Moreover, it is possible to examine several VGA ports simultaneously without switching in different computer systems.

### BRIEF DESCRIPTION OF THE DRAWINGS

The invention can be more fully understood by reading the following detailed description of the embodiment, with reference made to the accompanying drawings as follows:

FIG. 1 is the block diagram of the preferred embodiment of the VGA port signal examining apparatus of this invention.

FIGS. 2A and 2B are flowcharts of the VGA port signal examining method of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

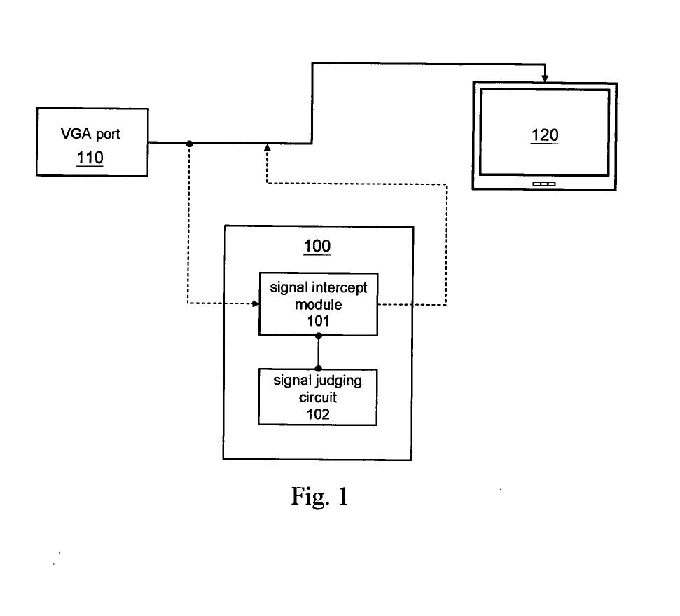

The present invention is a VGA port signal examining apparatus and method thereof, by examining relative data of the analog signals to determine whether the VGA port is normal or not. Refer to FIG. 1. FIG. 1 is the block diagram of the preferred embodiment of the VGA port signal examining apparatus of this invention. The VGA port signal examining apparatus 100 comprises a signal intercepting module 101 and a signal judging circuit 102. Wherein the signal intercepting module 101 connects to a VGA port 110 to intercept plural analog signals such as vertical signals, horizontal signals, R-signals, G-signals, and B-signals transmitted from the VGA port 110 to the monitor 120. The signal judging circuit 102 links to the signal intercepting module 101 and compares the magnitude of the analog signal with specific examination data set by a user, comprising judging means as follows:

(a) judging if the vertical signal is output on a specific frequency, wherein the specific frequency comprises one selected from 60 Hz, 70 Hz, and 85 Hz, etc.;

(b) judging if the magnitude of the horizontal signal exceeds a first level-potential around 1 volt; and

(c) judging if the magnitude of the R-signal, the magnitude of the G-signal, or the magnitude of the B-signal exceeds a second level-potential around 0.05 volt.

And, the signal judging circuit 102 determines whether analog signals transmission via the VGA port 110 is normal or not according to the comparisons.

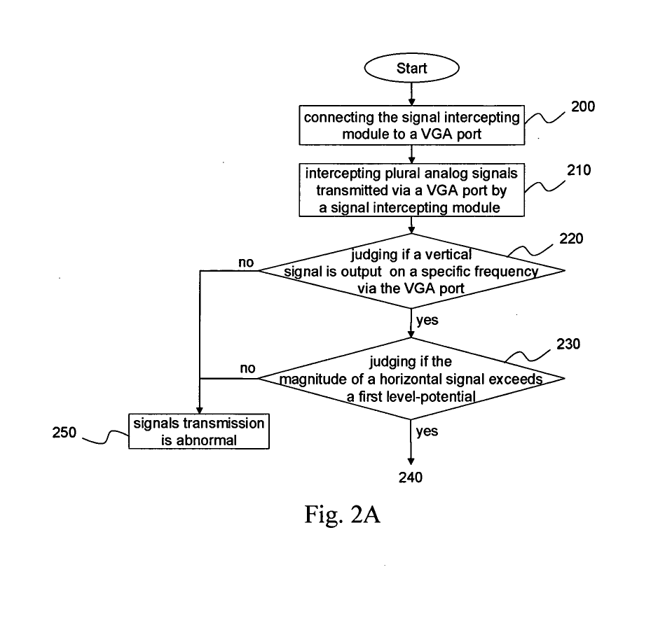

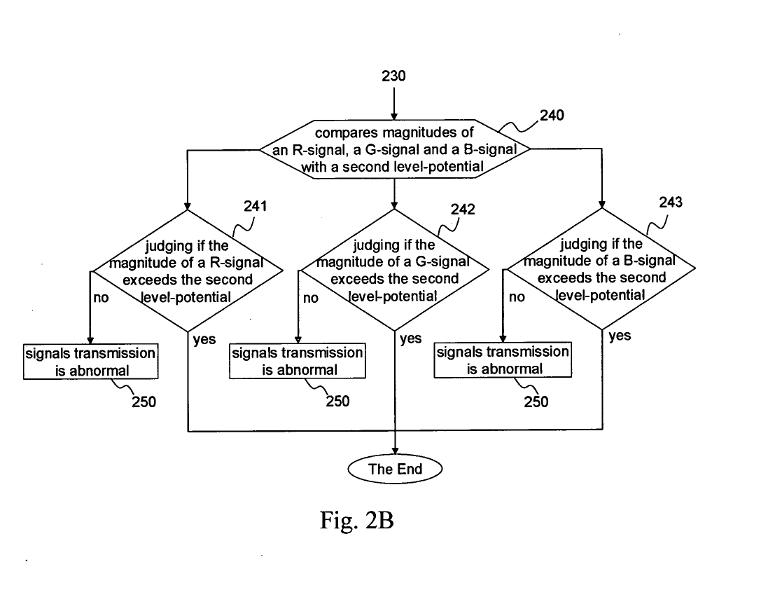

Refer to FIGS. 2A and 2B. FIGS. 2A and 2B are flowcharts of the VGA port signal examining method of this invention. As shown in FIG. 2A, the VGA port signal examining method of this invention applies firstly with connecting the signal intercepting module 101 of the signal examining apparatus 100 to a VGA port 110 (Step 200). Then, the signal intercepting module 101 intercepts plural analog signals transmitted via the VGA port 110 (Step 210), wherein the analog signals comprises a vertical signal, a horizontal signal, an R-signal, a G-signal and a B-signal. Then, the signal judging circuit 102 judges if a vertical signal is output on a specific frequency via the VGA port (Step 220), wherein the specific frequency comprises one selected from 60 Hz, 70 Hz, and 85 Hz, etc.. If the vertical signal does not output on the specific frequency, the signal examining apparatus 100 will determine the signals transmission via the VGA port 110 as abnormal (Step 250). As following Step 220, the signal judging circuit 102 judges if the magnitude of a horizontal signal exceeds a first level-potential (Step 230), wherein the first level-potential is around 1 volt. If the magnitude of the horizontal signal does not exceed the first level-potential, the signal examining apparatus 100 determines the signals transmitted via the VGA port 110 are abnormal (Step 250). After Step 230, the signal judging circuit 102 compares magnitudes of an R-signal, a G-signal and a B-signal with a second level-potential (Step 240), wherein the second level-potential is around 0.05 volt. Step 240 then diverges into 3 judging steps follow as: judging if the magnitude of an R-signal exceeds the second level-potential (Step 241); judging if the magnitude of a G-signal exceeds the second level-potential (Step 242); and, judging if the magnitude of a B-signal exceeds the second level-potential (Step 243). If the judging result in any of the above-mentioned Step 241, Step 242, or Step 243 is negative, the signal examining apparatus 100 will determine the signals transmitted via the VGA port 110 are abnormal (Step 250). But if all of the above-mentioned judging steps are affirmative, then the analog signals transmitted via the VGA port 110 are normal. Then, the method procedure is ended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A VGA port signal examining apparatus, comprising:
a signal intercepting module, connected to a VGA port to intercept plural analog signals transmitted from the VGA port to a monitor, wherein the analog signals comprises a vertical signal, a horizontal signal, an R-signal, a G-signal, and a B-signal; and
a signal judging circuit, linking to the signal intercepting module, and comparing the magnitude of the analog signals with specific examination data set by a user to determine whether analog signals transmitted via the VGA port being normal or not, wherein comparing the magnitude of the analog signals with specific examination data comprises judging means as follows:
(a) judging if the vertical signal is output on a specific frequency;
(b) judging if the magnitude of the horizontal signal exceeds a first level-potential; and
(c) judging if the magnitude of the R-signal, the magnitude of the G-signal, or the magnitude of the B-signal exceeds a second level-potential.

2. The VGA port signal examining apparatus of claim 1, wherein the specific frequency comprises one selected from 60 Hz, 70 Hz, and 85 Hz.

3. The VGA port signal examining apparatus of claim 1, wherein the first level-potential is 1 volt.

4. The VGA port signal examining apparatus of claim 1, wherein the second level-potential is 0.05 volt.

5. A VGA port signal examining method, comprising steps as follows:
intercepting plural analog signals transmitted via a VGA port by a signal intercepting module;
judging if a vertical signal is output on a specific frequency via the VGA port by a signal judging circuit;
judging if a magnitude of a horizontal signal exceeds a first level-potential by the signal judging circuit;
judging if a magnitude of an R-signal exceeds a second level-potential by the signal judging circuit;
judging if a magnitude of a G-signal exceeds the second level-potential by the signal judging circuit; and
judging if a magnitude of a B-signal exceeds the second level-potential by the signal judging circuit.

6. The VGA port signal examining method of claim 5, wherein the signal intercepting module connects to the VGA port to intercept plural analog signals which comprise the vertical signal, the horizontal signal, the R-signal, the G-signal and the B-signal, transmitted from the VGA port to a monitor.

7. The VGA port signal examining method of claim 5, wherein the signal judging circuit compares the magnitude of the analog signals with specific examination data set by a user.

8. The VGA port signal examining method of claim 5, wherein the specific examination data comprises the specific frequency, the first level-potential, and the second level-potential.

9. The VGA port signal examining method of claim 5, wherein the specific frequency comprises one selected from 60 Hz, 70 Hz, and 85 Hz.

10. The VGA port signal examining method of claim 5, wherein the first level-potential is 1 volt.

11. The VGA port signal examining method of claim 5, wherein the second level-potential is 0.05 volt.
